(19) United States
(12) Patent Application Publication
(10) Pub. No.: US 2017/0320651 A1
(43) Pub. Date: Nov. 9, 2017

(54) PACKAGE AND BUFFER MEMBER THEREOF

(71) Applicant: AVER INFORMATION INC., New Taipei City (TW)

(72) Inventors: Shu-Chen CHEN, New Taipei City (TW); Hui-Lun HUNG, New Taipei City (TW)

(73) Assignee: AVER INFORMATION INC., New Taipei City (TW)

(21) Appl. No.: 15/586,202

(22) Filed: May 3, 2017

(30) Foreign Application Priority Data
May 4, 2016 (TW) 105113888

(51) Int. Cl. B65D 81/107; B65D 19/00; B65G 69/30; B65D 19/44; B65D 81/05

(52) U.S. Cl. CPC B65D 81/107; B65D 19/44; B65D 81/056; B65G 69/30; B65D 19/0091; B65D 2519/00273; B65D 2519/00104; B65D 2519/00099; B65D 2519/00069; B65D 2519/00064; B65D 2519/00034; B65D 2519/00029; B65D 2519/00293; B65D 2519/00323; B65D 2519/00333; B65D 2519/00815; B65D 2581/055

(57) ABSTRACT

A buffer member has a first surface and a second surface opposite to each other. There is a buffer structure located on the first surface, and there is a slant located on the second surface for guiding a movement of an object relative to the buffer member. A package including the buffer member is provided therein.

### CROSS-REFERENCE TO RELATED APPLICATIONS

This non-provisional application claims priority under 35 U.S.C. §119(a) on Patent Application No(s). 105113888 filed in Taiwan, R.O.C. on May 4, 2016, the entire contents of which are hereby incorporated by reference.

### TECHNICAL FIELD

The disclosure relates to a package and a buffer member thereof, more particularly to a package and a buffer member for protective packaging.

### BACKGROUND

The products are shipped to many different places worldwide for sale. To protect the products during shipping, the products are well packaged in order to protect them from damage in transit. Generally, a package for the product includes one or more buffer members such as cardboards, wooden plates, polystyrene plates, acrylic plates or combination thereof.

However, some products are too heavy to be easily loaded on and unloaded from the package. When unloading the product, the product should be lifted up from the package and then put down on the ground, and thus such process consumes excessive manpower and material resources.

### SUMMARY

The present disclosure provides a package and a buffer member thereof for loading and unloading products easily.

According to the present disclosure, a buffer member has a first surface and a second surface opposite to each other. There is a buffer structure located on the first surface, and there is a slant located on the second surface for guiding a movement of an object relative to the buffer member.

According to the present disclosure, a package for packaging an object disposed on a transportable loader is provided. The transportable loader has a height between a top portion and a bottom portion thereof. The package includes a base and a first buffer member. The base is for supporting the object. The first buffer member has a first surface and a second surface opposite to each other, wherein there is a first buffer structure located on the first surface, there is a first slant located on the second surface, and a vertical depth of the first slant corresponds to the height of the transportable loader. When the package is in a packaged state, the first buffer member is disposed on the base, and the object is disposed near the first buffer structure. When the package is in an unloading state, the first buffer member is disposed on a side of the transportable loader, the first surface and the second surface of the first buffer member respectively correspond to the top portion and the bottom portion of the transportable loader, and the object is movable along the first slant so as to be unloaded from the base.

According to the present disclosure, there is a slant located on the surface of the buffer member for guiding the movement of the object relative to the buffer member. When the buffer member is used for unloading the object on the transportable loader, the vertical depth of the slant corresponds to the height of the transportable loader. When the package is in the unloading state, the buffer member is disposed on a side of the transportable loader, and the object is movable along the slant so as to be unloaded from the base. Therefore, the buffer member is used to protect the object when the package is in the packaged state. In addition, the buffer member having the slant is used as the ramp for loading/unloading the object, thereby the unloading/loading is efficient and does not cost much effort.

### BRIEF DESCRIPTION OF THE DRAWINGS

The present disclosure will become more understood from the detailed description given hereinbelow and the accompanying drawings which are given by way of illustration only and thus are not limitative of the present disclosure and wherein:

FIG. 1A is a perspective view of a package, a transportable loader and an object according to a first embodiment;

FIG. 1B is an exploded view of the package, the transportable loader and the object in FIG. 1A;

FIG. 1C and FIG. 1D are perspective views of a buffer member of the package in FIG. 1B and taken from different viewpoints;

FIG. 1E is a perspective view of the package, the transportable loader and the object in FIG. 1A with packaging member of the package removed;

FIG. 1F is a perspective view of the package, the transportable loader and the object in FIG. 1E with the package in an unloading state;

FIG. 1G is a perspective view of the package, the transportable loader and the object in FIG. 1F with a side board lying flat;

FIG. 1H is a perspective view of the package, the transportable loader and the object in FIG. 1G with two supporting members falling down;

FIG. 1I is a perspective view of the package, the transportable loader and the object in FIG. 1H with the object unloaded from the package;

FIG. 2A is a perspective view of a package, a transportable loader and an object according to a second embodiment;

FIG. 2B is a perspective view of the package, the transportable loader and the object in FIG. 2A with the package in an unloading state;

FIG. 3A is a perspective view of a package, a transportable loader and an object according to a third embodiment; and

FIG. 3B is a perspective view of the package, the transportable loader and the object in FIG. 3A with the package in an unloading state.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

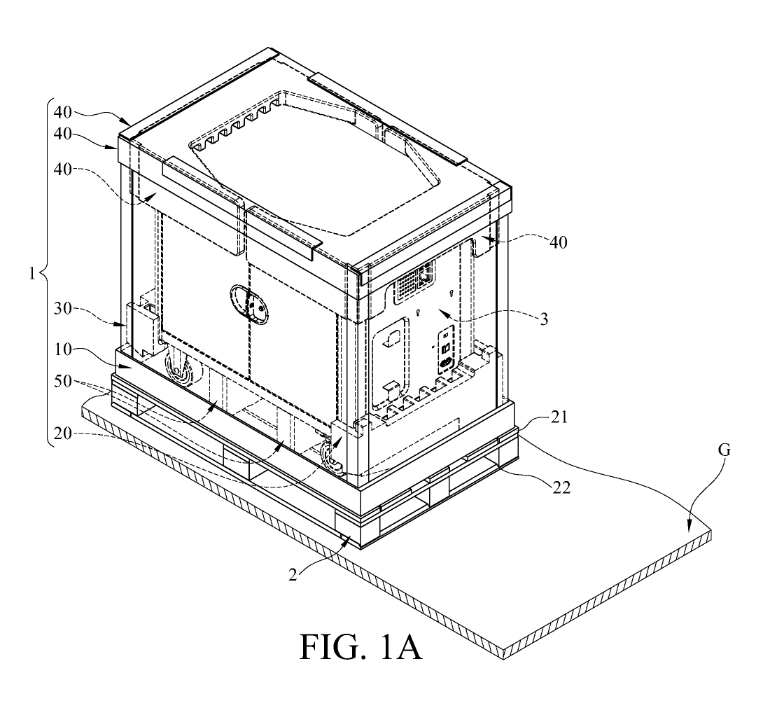

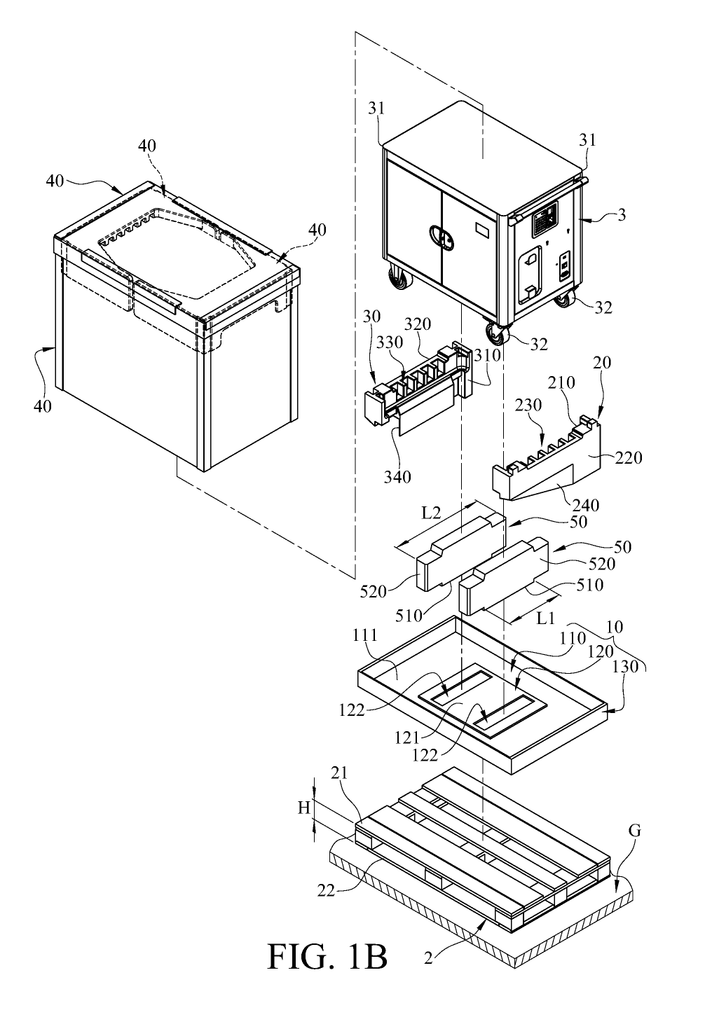

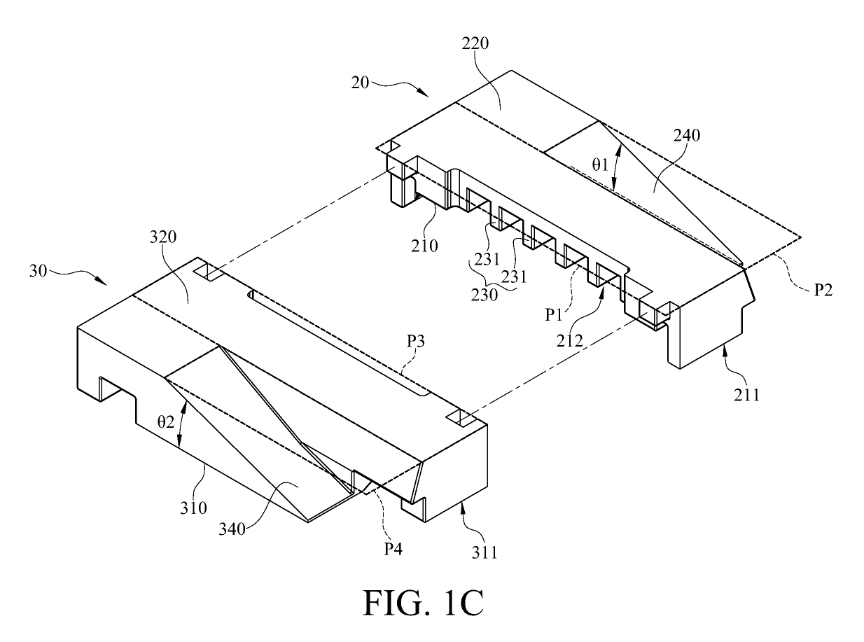

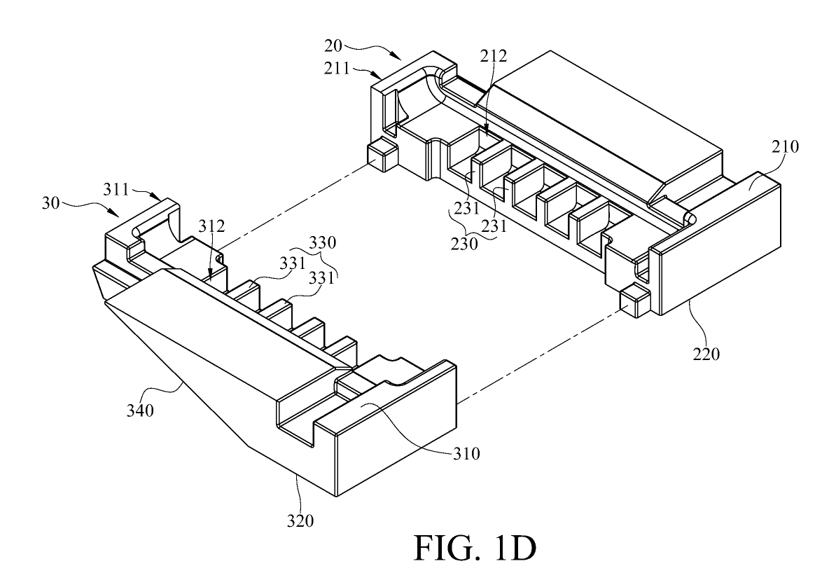

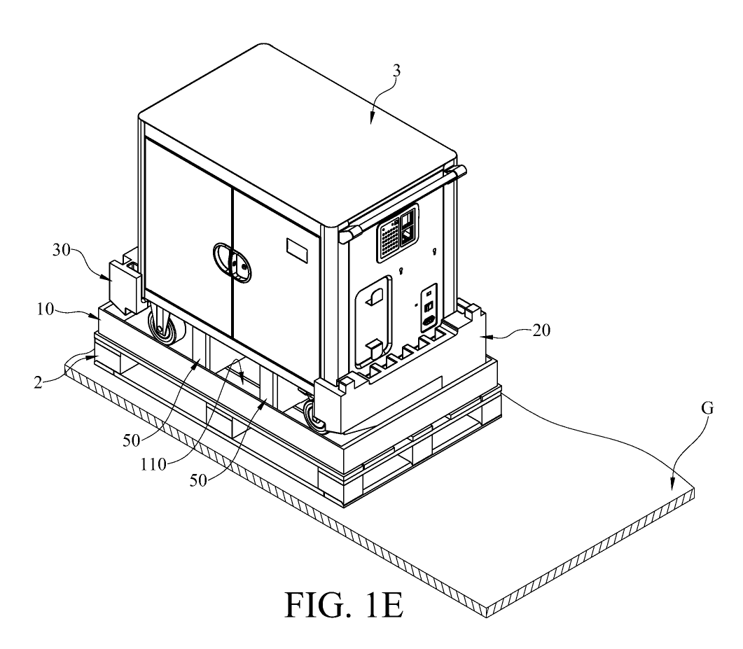

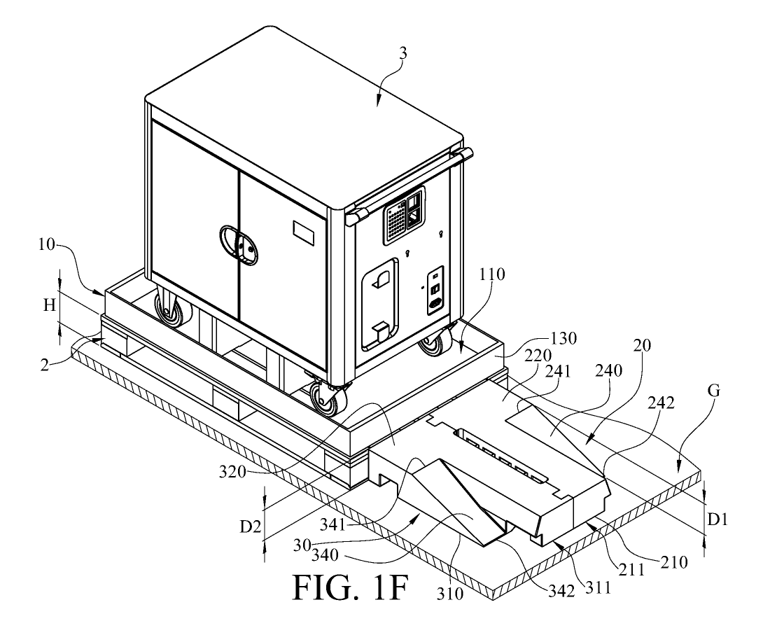

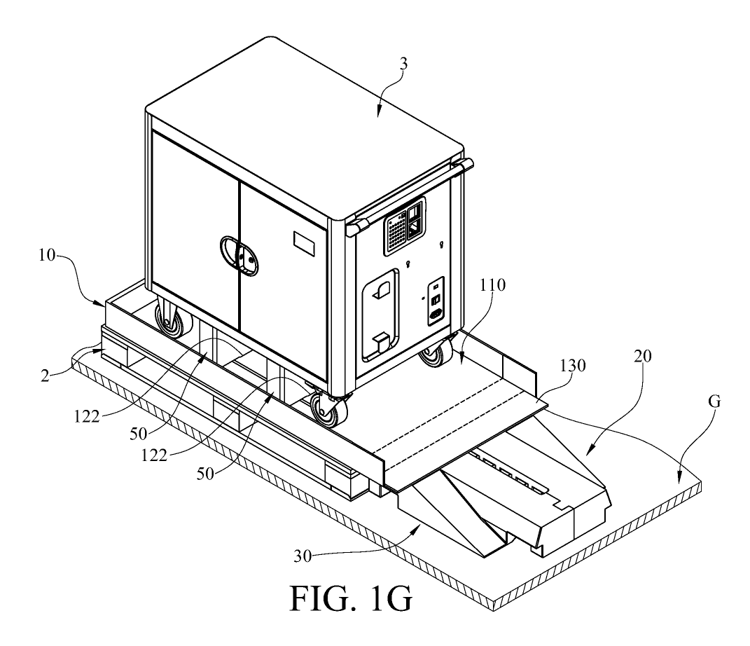

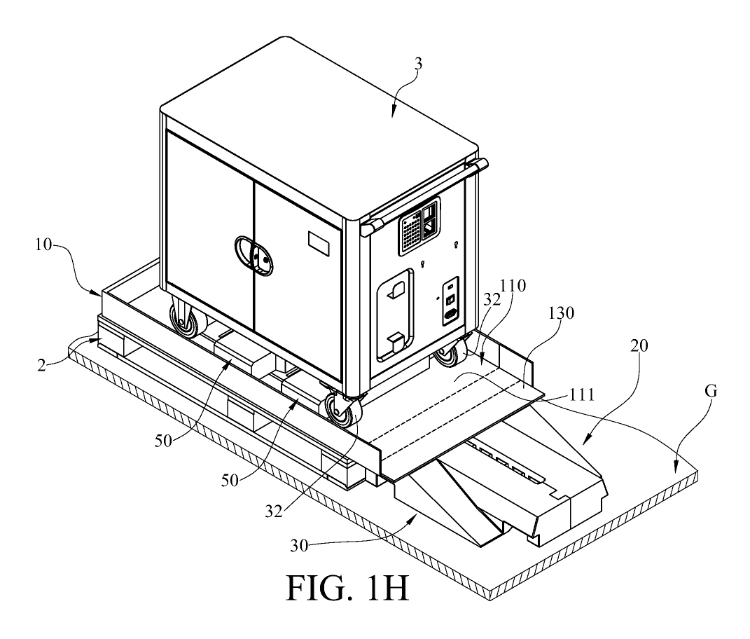

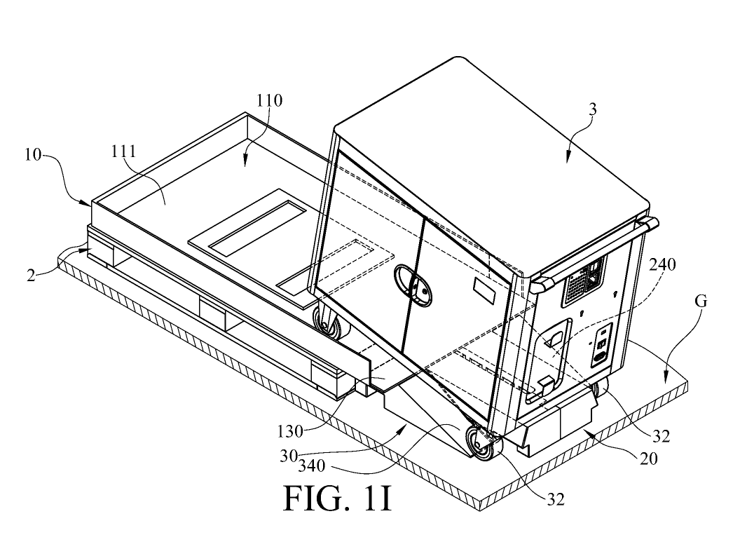

Please refer to FIGS. 1A to 1D. FIG. 1A is a perspective view of a package, a transportable loader and an object according to a first embodiment; FIG. 1B is an exploded view of the package, the transportable loader and the object in FIG. 1A; FIG. 1C and FIG. 1D are perspective views of a buffer member of the package in FIG. 1B and taken from different viewpoints.

In this embodiment, a package 1 includes a base 10, a buffer member 20, a buffer member 30, a plurality of packaging members 40 and two supporting members 50. The package 1 is adapted for packaging an object 3. The package 1 and the object 3 are disposed on a transportable loader 2. There is a height H between a top portion 21 and a bottom portion 22 of the transportable loader 2. The transportable loader 2, for example, can be a wooden or plastic pallet, a cart or a container truck. The object 3, for example, can be a charging cart, a home appliance or furniture. In this embodiment, the transportable loader 2 is a pallet, and the object 3 is a charging cart including plural wheels 32. In this embodiment, the aforementioned top portion 21 is a portion of the transportable loader 2 contacting the package 1 and supporting the object 3, and the aforementioned bottom portion 22 is a portion of the transportable loader 2 in contact with the ground G.

The base 10 includes a bottom board 110, a protrusion 120 and a side board 130. The bottom board 110 has a supporting surface 111, and the object 3 can be disposed on the supporting surface 111. The protrusion 120 protrudes from the supporting surface 111. The protrusion 120 has an assembling surface 121 and two holes 122. The assembling surface 121 is located on a side of the protrusion 120 opposite to the supporting surface 111, and the holes 122 are located on the assembling surface 121. The side board 130 is foldably connected to a side the bottom board 110 such that the side board 130 is able to stand on the bottom board 110 or be unfolded to lie flat. The height H of the transportable loader 2 is substantially equal to the distance between the object 3 and the ground G minus the thickness of the bottom board 110.

The buffer member 20 has a surface 210 and a surface 220 opposite to each other. There is a buffer structure 230 located on the surface 210, and there is a slant 240 located on the surface 220. The slant 240 is adapted for guiding the movement of the object 3 with respect to the buffer member 20. The buffer structure 230 can include a plurality of buffer ribs 231. The surface 210 can have a buffer section 211 and a recess 212 which is located on the buffer section 211. The buffer ribs 231 are disposed in the recess 212. An orthogonal projection P1 of the buffer section 211 on the surface 220 does not overlapped with an orthogonal projection P2 of the slant 240 on the surface 220.

The buffer member 30 has a surface 310 and a surface 320 opposite to each other. There is a buffer structure 330 located on the surface 310, and there is a slant 340 located on the surface 320. The slant 340 is adapted for guiding the movement of the object 3 with respect to the buffer member 30. The buffer structure 330 can include a plurality of buffer ribs 331. The surface 310 can have a buffer section 311 and a recess 312 which is located on the buffer section 311. The buffer ribs 331 are disposed in the recess 312. An orthogonal projection P3 of the buffer section 311 on the surface 320 does not overlapped with an orthogonal projection P4 of the slant 340 on the surface 320.

In this embodiment, the slants 240 and 340 are two planes which are respectively inclined relative to the surfaces 210 and 310, but the disclosure is not limited thereto. In some other embodiments, the slant located on the surface of the buffer member can be a curved plane or a groove. Furthermore, in this embodiment, each of the slants 240 and 340 has a width which is sufficient for the wheel 32 of the object 3 to run through.

The packaging members 40, for example, can be plural cardboards or expandable polystyrene (EPS) plates for packaging and protecting the object 3. In this embodiment, one of the packaging members 40 is a cardboard for covering the top of the object 3, two of the packaging members 40 are each an EPS plate for protecting the corners 31 of the object 3, and another one of the packaging members 40 is a cardboard for surrounding the object 3. However, the present disclosure is not limited to the quantity, the shape and the material of the packaging member 40. In some other embodiments, the package can include no packaging members; that is, the package can only include the base and the buffer member.

The two supporting members 50 are movably disposed on the base 10. In detail, each of the supporting members 50 includes an assembling portion 510 and a supporting portion 520 connected to each other. The length L1 of the assembling portion 510 is smaller than the length L2 of the supporting portion 520. The assembling portions 510 are respectively inserted into the holes 122 of the base 10, and each of the assembling portions 510 is pressed against the assembling surface 121. However, the present disclosure is not limited to the quantities of the supporting member 50 and the hole 122. The supporting portion 520 of the supporting member 50 is adapted for supporting the object 3 so as to space the object 3 apart from the supporting surface 111. Therefore, the object 3 is prevented from wobbling and protected from damage while in transit.

The object 3 is able to be unloaded from the base 10. Please refer to FIGS. 1A, 1E to 1I. FIG. 1E is a perspective view of the package, the transportable loader and the object in FIG. 1A with packaging member of the package removed; FIG. 1F is a perspective view of the package, the transportable loader and the object in FIG. 1E with the package in an unloading state; FIG. 1G is a perspective view of the package, the transportable loader and the object in FIG. 1F with a side board lying flat; FIG. 1H is a perspective view of the package, the transportable loader and the object in FIG. 1G with two supporting members toppling; and FIG. 1I is a perspective view of the package, the transportable loader and the object in FIG. 1H with the object unloaded from the package. In this embodiment, the package 1 has a packaging state (as shown in FIG. 1A) and an unloading state (as shown in FIG. 1F). In detail, when the package 1 is in the packaged state, the object 3 is packaged in the package 1, the buffer members 20 and 30 are disposed on the supporting surface 111 of the base 10 and respectively located on two opposite sides of the base 10. In addition, the buffer ribs 231 of the buffer structure 230 of the buffer member 20 and the buffer ribs 331 of the buffer structure 330 of the buffer member 30 are disposed near the object 3.

The process of unloading the object 3 is described hereafter. Firstly, as shown in FIG. 1E, the packaging members 40 is removed so as to leave the object 3 exposed to the outside.

Next, as shown in FIG. 1F, the buffer members 20 and 30 are moved to a side of the transportable loader 2, and the package 1 is changed from the packaged state to the unloading state. When the package 1 is in the unloading state, the buffer members 20, 30 are located on the same side of the transportable loader 2 and are assembled together. Furthermore, the buffer sections 211 and 311 are located between the slants 240 and 340; that is, the slants 240 and 340 are respectively located on opposite two sides of the assembled buffer members 20 and 30. Moreover, when the package 1 is in the unloading state, the surface 210 of the buffer member 20 and the surface 310 of the buffer member 30 correspond to the bottom portion 22 of the transportable loader 2, and the surface 220 of the buffer member 20 and the surface 320 of the buffer member 30 correspond to the top portion 21 of the transportable loader 2. Thus, the surfaces 210 and 310 are closer to the ground G than the surfaces 220 and 320.

Next, as shown in FIGS. 1F and 1G, the side board 130 is unfolded to lie flat, so an edge of the side board 130 opposite to the bottom board 110 is in contact with the buffer members 20 and 30.

Then, as shown in FIG. 1H, the object 3 is pulled or pushed by a user or a machine (not shown in the drawings) to move toward the buffer members 20 and 30. When the object 3 is moved, the object 3 force the supporting members 50 to move relative to the bottom board 110 so that the supporting members 50 are released from the holes 122 and fall down on the bottom board 110. Therefore, the object 3 is no longer supported by the supporting members 50 so that its wheels 32 are in contact with the supporting surface 111 and able to roll on the supporting surface 111. In the last step, as shown in FIG. 1I, the object 3 is moved over the slants 240, 340 to be unloaded from the base 10.

In this embodiment, as shown in FIG. 1F, the vertical depth D1 of the slant 240 and the vertical depth D2 of the slant 340 each correspond to the height H of the transportable loader 2. The vertical depth D1 is a vertical distance from the top edge 241 of the slant 240 to the bottom edge 242 of the slant 240 (i.e. a distance along a direction from the top portion 21 to the bottom portion 22 of the transportable loader 2), and is substantially equal to the height H. The vertical depth D2 is a vertical distance from the top edge 341 of the slant 340 to the bottom edge 342 of the slant 340 (i.e. a distance along the direction from the top portion 21 to the bottom portion 22), and is substantially equal to the height H. The statement “the vertical depths D1, D2 are substantially equal to the height H of the transportable loader 2” means that the difference between the vertical depths D1, D2 and the height H is sufficiently small. In this embodiment, the vertical depths D1, D2 are exactly equal to the height H, but the disclosure is not limited thereto. In some embodiments, the vertical depths D1, D2 are slightly larger than the height H such that the user can easily move the object 3 from the base 110 to the buffer members 20, 30 when the package is in the unloading state. In some embodiments, the vertical depths D1, D2 are slightly smaller than the height H such that it is favorable for preventing the object 3 from excessive vibration when the object 3 is moved from the base 10 to the buffer members 20 and 30.

Furthermore, in this embodiment, as shown in FIG. 1C, there is an acute angle θ1 between the slant 240 and the surface 210, and there is an acute angle θ2 between the slant 340 and the surface 310. Each of the acute angles θ1 and θ2 can be greater than or equal to 15 degrees and less than or equal to 30 degrees. When the inclination of the slants 240 and 340 is overly large, the object 3 may move overly fast when it is unloaded, and the object 3 is likely to collide with the surrounding objects or injure surrounding people. When the inclination of the slants 240 and 340 is overly small, the buffer members 20 and 30 should be designed extremely large in size to let the slants 240 and 340 have sufficient length, thereby the buffer members 20 and 30 are inapplicable to compact package. Therefore, the angles θ1 and θ2 with each ranging from 15 to 30 degrees are favorable for arranging the slants 240 and 340 with proper inclination and proper size thereof.

Moreover, in this embodiment, each of the buffer members 20 and 30 can be made of a foam material such as styrofoam, foamed polystyrene, foamed polyurethane and foamed polyethylene. In detail, each of the buffer members 20 and 30 can be made of a foam material having an expansion ratio of 60 times or less; that is, the expansion ratio can be 60:1 or less. In some embodiments, each of the buffer members 20 and 30 can be made of a foam material having an expansion ratio of 15 times to 30 times; that is, the expansion ratio can range from 15:1 to 30:1. Therefore, it is favorable for providing the buffer members 20 and 30 with sufficient capability for protecting the object 3 and sufficient strength for support the object 3. The buffer members 20 and 30 with high strength are favorable for preventing the buffer members 20 and 30 from being damaged or broken when loaded with overly heavy object, thereby improving the lifespan of the buffer members 20 and 30.

According to the disclosure, there is a slant 240 located on the buffer member 20, and there is a slant 340 located on the buffer member 30. Each of the vertical depths of the slants 240, 340 corresponds to the height H. When the package 1 is in the unloading state, the buffer members 20 and 30 are disposed on a side of the transportable loader 2, and the object 3 is movable along the slants 240 and 340 so as to be unloaded from the base 10. Therefore, the buffer members 20 and 30 are used to protect the object 3 when the package 1 is in the packaged state. In addition, the buffer members 20 and 30 can be assembled to be a ramp for unloading the object 3, thus the unloading is efficient and does not cost much effort.

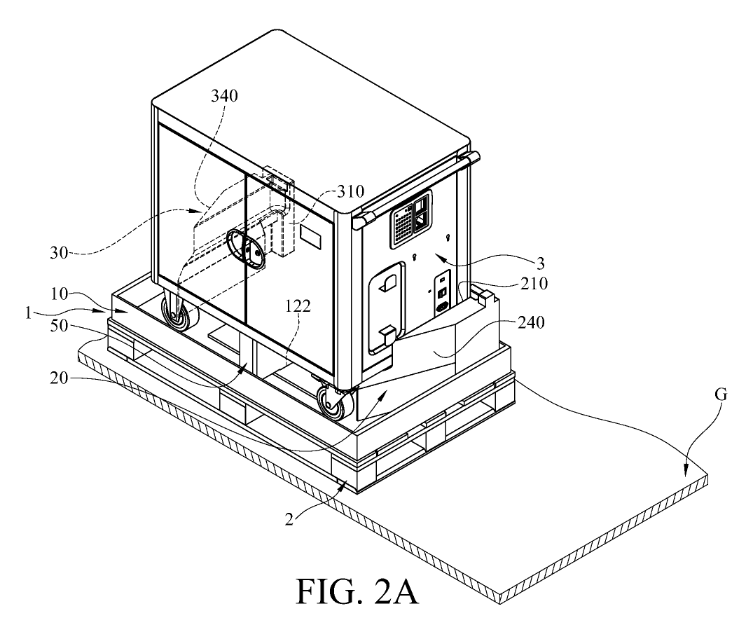

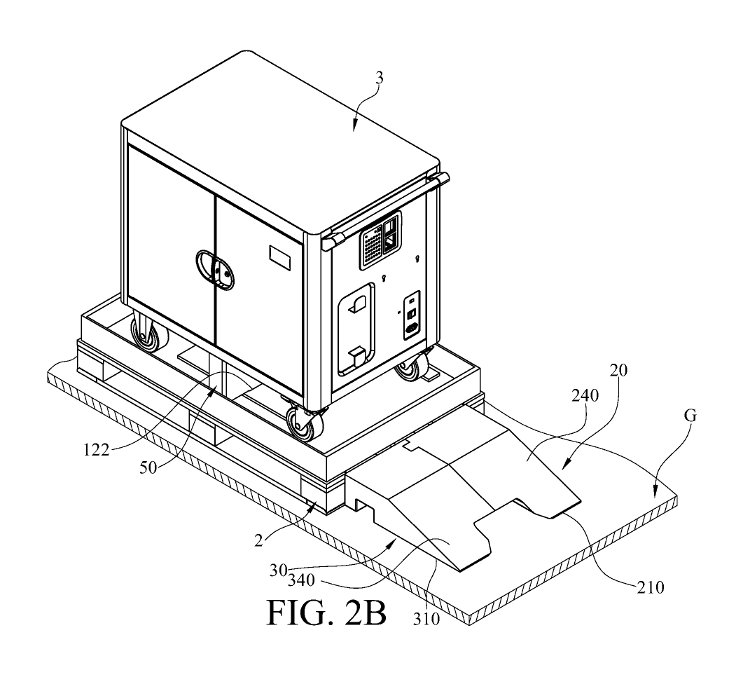

In the first embodiment, each of the buffer members includes plural buffer ribs, and the package includes plural supporting members, but the disclosure is not limited thereto. Please refer to FIGS. 2A and 2B. FIG. 2A is a perspective view of a package, a transportable loader and an object according to a second embodiment; and FIG. 2B is a perspective view of the package, the transportable loader and the object in FIG. 2A with the package in an unloading state. Since the second embodiment is similar to the first embodiment, only the differences will be illustrated hereafter.

In this embodiment, each of the buffer members 20 and 30 includes no buffer ribs; that, is, each of the surfaces surface 210 and surface 310 is flat. Furthermore, there is no buffer section located on the surfaces 210 and 310. When the package 1 is in the unloading state, the buffer members 20 and 30 are assembled together, and the slants 240, 340 are connected to each other so as to jointly form an inclined plane. In this embodiment, the package 1 include only one supporting member 50, and the base 10 has only one hole 122. The supporting member 50 can has a larger size than the supporting member in the first embodiment such that the strength of the supporting member 50 is sufficient to support the object 3.

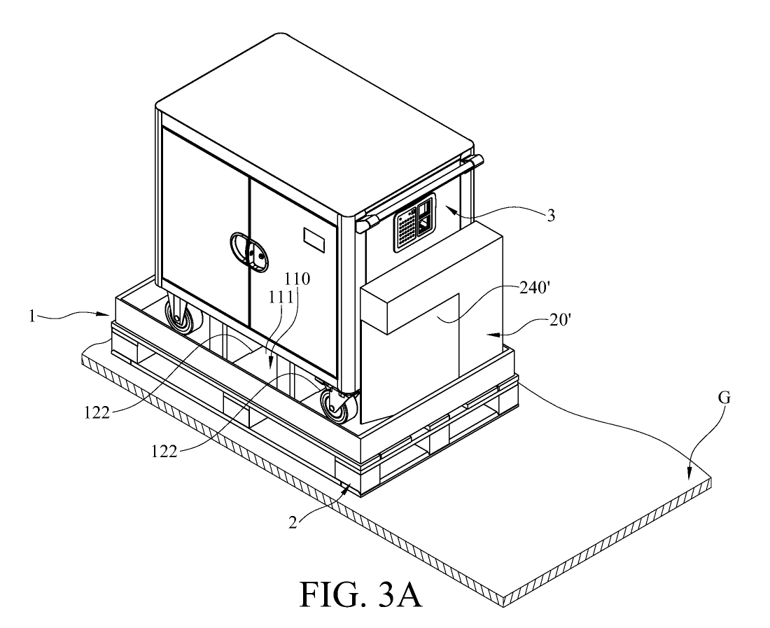

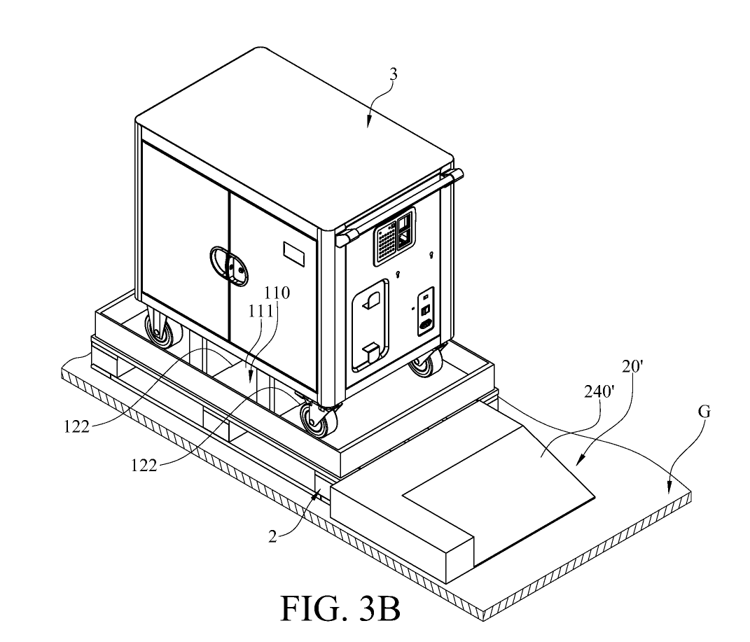

In the first and the second embodiments, two buffer members through which the object can be unloaded from the base to the ground are provided, but the quantity of the buffer members is not limited thereto. Please refer to FIGS. 3A and 3B. FIG. 3A is a perspective view of a package, a transportable loader and an object according to a third embodiment; and FIG. 3B is a perspective view of the package, the transportable loader and the object in FIG. 3A with the package in an unloading state. Since the third embodiment is similar to the first embodiment, only the differences will be illustrated hereafter.

In this embodiment, the package 1 includes a buffer member 20′, and there is a slant 240′ located on a surface of the buffer member 20′. The width of the slant 240′ corresponds to the width of the object 3. The buffer member 20′ has the same configuration as the buffer member 20 in the first embodiment such that any illustration for the detail of the buffer member 20′ is omitted. When the package 1 is in the unloading state, the object 3 is movable along the slant 240′ so as to be unloaded from the base 10. Furthermore, in this embodiment, the base 10 includes no protrusion, and the hole 122 is located on the supporting surface 111 of the bottom board 110.

The first through the third embodiments illustrate that the object 3 can be unloaded from the base through the buffer member when the package is in the unloading state, but the disclosure is not limited thereto. The object 3 can be loaded on the base through the buffer member by the reverse operation.

According to the disclosure, there is a slant located on the surface of the buffer member for guiding the movement of the object relative to the buffer member. When the buffer member is used for unloading the object on the transportable loader, the vertical depth of the slant corresponds to the height of the transportable loader. When the package is in the unloading state, the buffer member is disposed on a side of the transportable loader, and the object is movable along the slant so as to be unloaded from the base. Therefore, the buffer member is used to protect the object when the package is in the packaged state. In addition, the buffer member having the slant is used as the ramp for loading/unloading the object, thereby the unloading/loading is efficient and does not cost much effort.

Furthermore, the vertical depth of the slant corresponds to the height of the transportable loader, so the user can easily move the object from the base to the buffer member, and the object is prevented from vibration when the object is moved from the base to the buffer member.

Moreover, the buffer member can be made of a foam material having an expansion ratio of 60 times or less. In some embodiments, the buffer member can be made of a foam material having an expansion ratio of 15 times to 30 times. Therefore, it is favorable for providing the buffer member with sufficient capability for protecting the object and sufficient strength for support the weight of the object. The buffer member with high strength is prevented from being damaged or broken by the overly heavy object, and thereby improving the lifespan of the buffer member.

In addition, the supporting member space the object apart from the base such that it is favorable for preventing the object from overly wobbling when the object is in transit, thereby reducing damage to the object. The supporting member is movable relative to the base so that the object can be moved to force the supporting member to fall down. When the supporting member is fall down, the object is in contact with the supporting surface of the base so that the object can be moved relative to the base to be unloaded to the ground by running through the slant of the buffer member.

While this disclosure has been described in terms of several preferred embodiments, there are alterations, permutations, and equivalents, which fall within the scope of this disclosure. It should also be noted that there are many alternative ways of implementing the methods and apparatuses of the present disclosure. It is therefore intended that the following appended claims be interpreted as including all such alterations, permutations, and equivalents as fall within the true spirit and scope of the present disclosure.

What is claimed is:

1. A buffer member having a first surface and a second surface opposite to each other, wherein there is a buffer structure located on the first surface, there is a slant located on the second surface for guiding a movement of an object relative to the buffer member.

2. The buffer member according to claim 1, wherein there is an acute angle between the slant and the first surface, and the acute angle is greater than or equal to 15 degrees and less than or equal to 30 degrees.

3. The buffer member according to claim 1, wherein the buffer structure comprises a plurality of buffer ribs, the first surface has a buffer section and a recess located on the buffer section, an orthogonal projection of the buffer section on the second surface does not overlap with an orthogonal projection of the slant on the second surface, and the plurality of buffer ribs is disposed in the recess.

4. The buffer member according to claim 1, wherein the buffer member is made of a foam material having an expansion ratio of 60 times or less.

5. The buffer member according to claim 4, wherein the buffer member is made of the foam material having the expansion ratio of 15 times to 30 times.

6. A package for packaging an object disposed on a transportable loader, the transportable loader having a height between a top portion and a bottom portion thereof, the package comprising:
a base for supporting the object; and
a first buffer member having a first surface and a second surface opposite to each other, wherein there is a first buffer structure located on the first surface, there is a first slant located on the second surface, and a vertical depth of the first slant corresponds to the height of the transportable loader;
wherein when the package is in a packaged state, the first buffer member is disposed on the base, and the object is disposed near the first buffer structure;
wherein when the package is in an unloading state, the first buffer member is disposed on a side of the transportable loader, the first surface and the second surface of the first buffer member respectively correspond to the top portion and the bottom portion of the transportable loader, and the object is movable along the first slant so as to be unloaded from the base.

7. The package according to claim 6, further comprising a second buffer member, the second buffer member having a third surface and a fourth surface, wherein there is a second buffer structure located on the third surface, there is a second slant located on the fourth surface, and a vertical distance of the second slant corresponds to the height between the top portion and the bottom portion;
wherein when the package is in the packaged state, the first buffer member and the second buffer member are respectively disposed on two sides of the base opposite to each other, when the package is in the unloading state, the first buffer member and the second buffer member are assembled to each other, the third surface and the fourth surface of the second buffer member respectively correspond to the top portion and the bottom portion of the transportable loader, and the object is movable along the first slant and the second slant so as to be unloaded from the base.

8. The package according to claim 7, wherein the first surface of the first buffer member has a first buffer section, an orthogonal projection of the first buffer section on the second surface does not overlap with an orthogonal projection of the first slant on the second surface, the third surface of the second buffer member has a second buffer section, an orthogonal projection of the second buffer section on the fourth surface does not overlap with an orthogonal projection of the second slant on the fourth surface, when the package is in the unloading state, the first buffer section and the second buffer section are connected to each other, and the first buffer section and the second buffer section are located between the first slant and the second slant.

9. The package according to claim 6, wherein the base comprises a bottom board and a side board foldably connected to a side of the bottom board, when the package is at the unloading state, the side board is unfolded to lie flat on the first buffer member.

10. The package according to claim 6, further comprising at least one supporting member movably disposed on the base for supporting the object.

11. The package according to claim 10, wherein the base has at least one hole, and the at least one supporting member is inserted into the at least one hole.

12. The package according to claim 11, wherein the base comprises a bottom board and a protrusion, the bottom board has a supporting surface for supporting the object, the protrusion is located on the supporting surface, the protrusion has an assembling surface located on a side of the protrusion opposite to the supporting surface, and the at least one hole is located on the assembling surface.

13. The package according to claim 12, wherein the at least one supporting member comprises an assembling portion and a supporting portion connected to each other, the assembling portion is inserted into the at least one hole, the supporting portion is pressed against the assembling surface, and a length of the assembling portion is smaller than that of the supporting member.
